(19) United States
(12) Patent Application Publication
(10) Pub. No.: US 2018/0013150 A1
(43) Pub. Date: Jan. 11, 2018

(54) FUEL CELL CATALYST SUITABLE FOR NON-HUMIDIFIED CONDITIONS AND METHOD FOR MANUFACTURING THE SAME

(71) Applicant: Hyundai Motor Company, Seoul (KR)

(72) Inventor: Mi-Hye YI, Yongin-si (KR)

(21) Appl. No.: 15/369,538

(22) Filed: Dec. 5, 2016

(30) Foreign Application Priority Data
Jul. 7, 2016 (KR) 10-2016-0086041

(51) Int. Cl. H01M 4/92; H01M 4/86

(52) U.S. Cl. CPC H01M 4/926; H01M 4/8663

(57) ABSTRACT

A non-aqueous fuel cell catalyst includes a carbon support medium; a coating layer comprising a proton-conducting polymer including a phosphoric acid group coated on a surface of the carbon support medium; and a support member comprising platinum or a platinum alloy supported on the coating layer.

### CROSS-REFERENCE TO RELATED APPLICATION

This application claims the benefit of priority to Korean Patent Application No. 10-2016-0086041, filed on Jul. 7, 2016 in the Korean Intellectual Property Office, the entirety of which is incorporated herein by reference.

### TECHNICAL FIELD

The present disclosure relates to a fuel cell catalyst which can be operated under a non-aqueous condition, that is, in the absence of humidity. More specifically, the present disclosure relates to a non-aqueous fuel cell catalyst which allows protons and electrons to migrate through a polymer membrane between a carbon support medium and a platinum fuel cell catalyst to allow for the migration of protons and electrons under conditions including no humidity, low humidity and suitable humidity by coating the surface of a high-durability support medium for fuel cells (CNT, fullerene or the like) with a proton-conducting polymer having a phosphoric acid group chemically bonded thereto and then synthesizing a platinum (Pt)-containing fuel cell catalyst.

### BACKGROUND

Major energy sources such as fossil fuels, nuclear power and hydropower are indispensible in modern society and dependency thereon is increasing.

However, as problems such as depletion of these energy sources and environmental pollution arise, developed countries have led efforts to use energy more efficiently and to develop alternative energy sources, and have focused on improving technical skills to research and develop advances in the energy industry.

Korea, which imports most of the raw materials it uses for energy sources due to its lack of natural resources, urgently requires the development and use of novel techniques capable of improving energy utilization efficiency and solving pollution problems. This is especially true because of significantly increased electricity consumption since 2000. Furthermore, there has been enormous investment and development into high capacity power stations.

As the importance of alternative energy has risen due to the current rapid rise in oil prices and environmental regulations caused by the United Nations framework convention on climate change, fuel cells are attracting increased attention as alternative next-generation power energy sources. A fuel cell is a kind of direct current generator that directly converts chemical energy of a fuel into electrical energy, and has no limitation on Carnot cycles, unlike other electricity generators and thus has higher energy efficiency and reduced noise, vibration and exhaust gas problems relative to other electricity generators.

In addition, fuel cells can provide for the continuous generation of electricity so long as the fuels and an oxidant are continuously supplied, whereas primary and secondary batteries store and supply limited energy. Depending on the electrolyte and driving temperature, fuel cells are divided into alkaline fuel cells (AFC), phosphoric acid fuel cells (PAFC), molten carbonate fuel cells (MCFC), polymer electrolyte membrane fuel cells (PEMFC), solid oxide fuel cells (SOFC), direct methanol fuel cells (DMFC) and the like.

Among fuel cells, polymer electrolyte membrane fuel cells (PEMFCs) offer rapid start-up due to low operation temperature relative to other high-temperature fuel cells, can be easily manufactured using a solid electrolyte and provide high power and thus receive much attention as energy sources for distributed and dispersed power supply used in motors, homes or the like.

As shown in FIG. 1, the polymer electrolyte membrane fuel cell (PEMFC) is based on the principle in which, in an anode and a cathode, which are disposed via an electrolyte, hydrogen ions produced by oxidization of hydrogen at the anode reacts with oxygen at the cathode to produce water, which results in the generation of electricity.

One currently used fuel cell polymer electrolyte membrane is perfluorosulfonic acid-based Nafion, which is expensive and which has decreased hydrogen ion conductivity and cell function which is rapidly deteriorated due to hydration of the membrane at 80° C. or higher.

Accordingly, PEMFCs using humidity systems involve deteriorated electrode activity and serious toxicity by carbon monoxide (CO) due to low operation temperature. In addition, an additional facility for water management to apply humidity to the membrane is required, which causes deterioration in the efficiency of fuel cells and an increase in price and is thus the chief obstacle to the commercialization of fuel cells.

In an attempt to solve these problems, materials which have superior hydrogen ion conductivity, electrochemical stability and thermal stability even under high-temperature no-humidity (non-aqueous) conditions have been used as polymer electrolytes for fuel cells. Of such materials, use of phosphoric acid-doped polybenzimidazole-based polymer electrolytes has become more prevalent (Japanese Patent Laid-open Publication No. 2000-195528). However, phosphoric acid is released by water produced at the cathode when such electrolytes are used, and hydrogen ion conductivity on the electrolyte membrane is decreased.

Accordingly, research has been undertaken into novel approaches to lower the cost of polymer electrolyte membranes using non-aqueous polymer electrolytes, and also to improve high temperature stability, hydration stability and electrochemical properties.

In addition, the fuel cell includes an anode, a cathode and an electrolyte and generates electricity by catalysis of the anode and the cathode and permeation of ions on the electrolyte. The fuel cell is mainly classified depending on the used electrolyte and is broadly classified into a low temperature fuel cell and a high temperature fuel cell. The low temperature fuel cell requires high catalytic reactivity and ion permeability at a low temperature to obtain a desired amount of energy. Accordingly, both an electrode catalyst and an electrolyte are essential factors in determining the overall performance. Currently, platinum supported on a support medium is the most commonly used electrode catalyst in the low temperature fuel cell. Platinum is a sole catalyst capable of promoting oxidation of fuels (hydrogen or alcohol) and reduction of oxygen within the temperature range from room temperature to 100° C. However, it is very important to use as little platinum as possible or to maximize activity thereof per unit weight because platinum is expensive. In order to accomplish this, an active reaction area should be maximized by controlling the size of particles of platinum on a support medium within a nano-scale. In addition, as the thickness of the catalytic layer in a fuel cell decreases, performance reduction resulting from diffusion deterioration can be alleviated. For this reason, a high supported catalyst containing a smaller amount of support medium is needed. Thus, there is an urgent need for production of platinum/support catalysts having fine platinum particles in high supported areas.

In addition, currently used fuel cell electrode catalysts have problems of low hydrogen ion conductivity and deteriorated performance under non-aqueous operation conditions.

Accordingly, in order to solve these problems, in accordance with the present disclosure, the surface of a high-durability support medium for fuel cells (CNT, fullerene or the like) is coated with a proton-conducting polymer having a phosphoric acid group chemically bonded thereto and a platinum (Pt)-containing fuel cell catalyst is then synthesized.

### SUMMARY

Therefore, the present disclosure has been made in view of the above problems, and it is an object of the present disclosure to synthesize a platinum (Pt)-containing fuel cell catalyst after coating the surface of a high-durability support medium for fuel cells (CNT, fullerene or the like) with a proton-conducting polymer including a phosphoric acid group.

The objects of the present disclosure are not limited to those described above and other objects not stated herein may be clearly understood by those skilled in the art from the following description.

In accordance with the present disclosure, the above and other objects can be accomplished by the provision of a non-aqueous fuel cell catalyst including a carbon support medium, a coating layer including a proton-conducting polymer including a phosphoric acid group coated on a surface of the carbon support medium, and a support member including platinum or a platinum alloy supported on the coating layer.

The proton-conducting polymer may include polybenzoimidazole, polyetherketone, polyester, polyimide, polystyrene or polyamide.

The carbon support medium may include a carbon nanotube (CNT), a fullerene, graphene or a mixture thereof.

The coating layer may have a thickness of 0.5 to 5 nm.

The coating layer may include: 1,1′-bis(diphenylphosphino)ferrocene; 3-bromopropyl amine, sodium t-butoxide or a mixture thereof; or bis(dibenzylideneacetone)palladium, dimethylacetamide, dimethylformamide or a mixture thereof.

A content of the 1,1′-bis(diphenylphosphino)ferrocene may be within a range of 10 to 30 wt %, based on 100 wt % of the proton-conducting polymer, a content of the 3-bromopropyl amine may be within a range of 40 to 80 wt %, based on 100 wt % of the proton-conducting polymer, a content of the sodium t-butoxide may be within a range of 5 to 20 wt %, based on 100 wt % of the proton-conducting polymer, and a content of the bis(dibenzylideneacetone)palladium may be within a range of 10 to 30 wt %, based on 100 wt % of the proton-conducting polymer.

In accordance with another aspect of the present disclosure, a method of manufacturing a non-aqueous fuel cell catalyst includes mixing a carbon support medium with a proton-conducting polymer including a phosphoric acid group, sealing the mixture in a vial, reacting the sealed mixture in a microwave reactor, adding ethylene glycol (EG) and hexachloroplatinic acid (H₂PtCl₆) to the reacted mixture, heating and refluxing the resulting mixture to 120° C. using a using a total condenser or a partial condenser, and centrifuging the refluxed substance and then washing the same.

The proton-conducting polymer may include polybenzoimidazole, polyetherketone, polyester, polyimide, polystyrene or polyamide.

The carbon support medium may include carbon nanotube (CNT), fullerene, graphene or a mixture thereof.

In the mixing, 1,1′-bis(diphenylphosphino)ferrocene, 3-bromopropyl amine, sodium t-butoxide or a mixture thereof, bis(dibenzylideneacetone)palladium, dimethylacetamide, dimethylformamide or a mixture thereof may be further mixed.

The reaction may be carried out in a microwave reactor at a temperature of 150 to 200° C. for 1 to 3 hours.

The hexachloroplatinic acid (H₂PtCl₆) may have a platinum support ratio of 20 to 65%, with respect to carbon and the ethylene glycol may be a 60% aqueous solution.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows deterioration in activity of platinum by which a catalyst is sufficiently covered with a conventional polybenzimidazene (polybenzimidazole) incorporated in the production of a slurry; and

FIG. 2 shows movement of a proton and an electron through a polymer membrane between a support medium and a platinum catalyst according to an exemplary embodiment in the present disclosure.

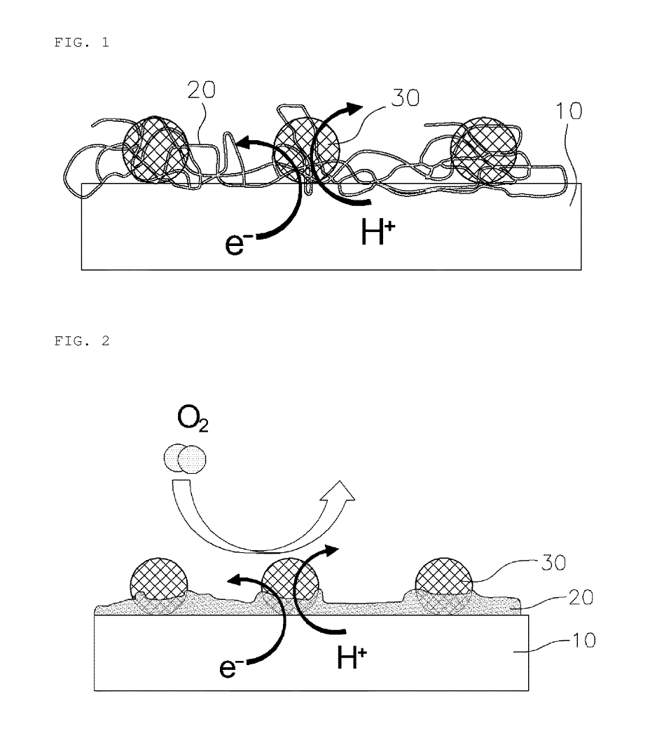

### DETAILED DESCRIPTION OF THE EMBODIMENTS

Hereinafter, the present disclosure will be described in detail in such a manner that it can be easily implemented by a person having ordinary knowledge in the field to which the present disclosure pertains. However, the present disclosure should not be construed as being limited to the embodiments set forth herein.

A detailed description of parts unrelated to the description will be omitted for clarity and like reference numerals refer to identical or similar elements throughout the specification.

In addition, the terms and words used in the present specification and claims should not be construed to be limited to the common or dictionary meaning, because an inventor can define the concept of the terms appropriately to describe his/her disclosure in the best manner. Therefore, they should be construed as a meaning and concept fit to the technological concept and scope of the present disclosure.

Hereinafter, exemplary embodiments in the present disclosure will be described in detail with reference to the accompanying drawings.

FIG. 2 shows movement of a proton and an electron through a polymer membrane between a support medium and a platinum catalyst according to an exemplary embodiment in the present disclosure.

In an exemplary embodiment of the present disclosure, the surface of a high-durability support medium 10 including a carbon support medium is coated with a proton-conducting polymer 20 having a phosphoric acid group chemically bonded thereto and then supporting platinum or a platinum alloy on the surface thereof to synthesize a platinum fuel cell catalyst 10.

The proton-conducting polymer may include polybenzoimidazole, polyetherketone, polyester, polyimide, polystyrene, polyamide or the like.

The carbon support medium may include a carbon nanotube (CNT), fullerene or graphene.

The thickness of the polymer membrane coated on the surface of the carbon support medium is preferably 0.5 to 5 nm. This is because an excessive polymer membrane thickness may cause electrical disconnection between carbon and the platinum catalyst.

As shown in FIG. 2, the present disclosure allows for the migration of protons and electrons through the polymer membrane between the carbon support medium 10 and the platinum fuel cell catalyst 30 to allow for the migration of protons and electrons under all conditions including no-humidity, low humidity and suitable humidity.

The proton-conducting polymer may be, for example, polybenzimidazole (PBI or polybenzimide), which may be used for hydrocarbon membranes for high temperature/no humidity fuel cell membrane-electrode assemblies (MEAs) and hydrocarbon electrolyte membranes. PBI may be used as an alternative to fluorine-based membranes because it has a very high melting point and an increased conductivity upon impregnation with phosphoric acid, sulfuric acid or the like.

In addition, polyetherketone, polyester, polyimide, polystyrene or polyamide may be also used.

A method of manufacturing a non-aqueous fuel cell catalyst according to the present disclosure will be described below.

First, a test reagent prepared by mixing a polymer substance with 1,1′-bis(diphenylphosphino)ferrocene; 3-bromopropyl amine or sodium t-butoxide; and bis(dibenzylideneacetone)palladium; and dimethylacetamide (DMA) or dimethylformamide (DMF) and CNT is sealed in a microwave vial.

Then, the reagent is reacted in the microwave reactor at 150 to 170° C. for 2 hours to prepare a polymer coating material.

Then, a mixture of the polymer coating material with ethylene glycol (EG) and hexachloroplatinic acid (H₂PtCl₆) is heated and refluxed at 120° C. using a total condenser or a partial condenser.

Then, the refluxed substance was centrifuged and washed to obtain a fuel cell catalyst.

More specifically, one aspect of the present disclosure is directed to a non-aqueous fuel cell catalyst. Conventional fuel cell catalyst electrodes have problems of low conductivity of hydrogen ions in an electrode under non-aqueous operation conditions and this may lead to deteriorated performance and lowered durability. In accordance with the present disclosure, the surface of a high-durability support medium is coated with a proton-conducting polymer having a phosphoric acid group chemically bonded thereto and platinum or a platinum alloy is supported thereon to synthesize a fuel cell catalyst. The proton-conducting polymer is generally used for a hydrocarbon-based membrane in the development of high-temperature no-humidity fuel cell MEAs, which is used as an alternative to fluorine-based membranes because it has a very high melting point and has increased conductivity upon impregnation with phosphoric acid, sulfuric acid or the like. Additionally, the proton-conducting polymer may be blended with a fluorine-based substance. The proton-conducting polymer may be polybenzoimidazole, polyetherketone, polyester, polyimide, polystyrene, polyamide or the like.

In the prior art, very low proton transfer capacity in the electrode is observed under non-aqueous conditions. When the surface of the carbon support medium is coated with a proton-conducting polymer having a phosphoric acid group chemically bonded thereto, proton transfer capacity is advantageously high regardless of the humidity condition. In general, a proton-conducting polymer is impregnated (doped) with phosphoric acid or sulfuric acid. In this case, when the fuel cell operates, an acid substance is melted, and conductivity is gradually decreased and performance is thus deteriorated. However, when a substance containing phosphoric acid and a proton-conducting polymer which are chemically bonded to each other is prepared and then applied to the surface of carbon, the acid substance cannot be melted as the fuel cell operates. Accordingly, the present disclosure maintains the performance and improves the durability of the fule cell. In the present disclosure, the thickness of the polymer coated on the surface of the carbon support medium is preferably 0.5 to 5 nm. When the thickness is less than 0.5 nm, coating may be not conducted well, and when the thickness exceeds 5 nm, electrical disconnection between carbon and the platinum catalyst may be induced.

When the non-aqueous fuel cell catalyst according to an exemplary embodiment in the present disclosure is synthesized, an ionomer is applied to the surface of carbon by coating the surface thereof with a proton-conducting polymer and then supporting the same on platinum. That is, since a proton-conducting polymer having a phosphoric acid group chemically bonded thereto is adhered to the surface of the carbon support medium, and platinum or a platinum alloy is then supported, electrons and protons can be further easily moved between the carbon support medium, the proton-conducting polymer and platinum, and since the surface of platinum is not covered with the proton-conducting polymer, the platinum active area can be maintained. Consequently, the non-aqueous fuel cell catalyst is obtained by dispersing a mixture containing Pt-polymer coated carbon, pure water (DI) and IPA using ultrasonic waves while stirring, adding a radical scavenger (Ce, CeOx, Zr, ZrOx or the like) thereto and dispersing the resulting mixture using ultrasonic waves while stirring.

In accordance with the present disclosure, protons and electrons may migrate through the polymer membrane between the carbon support medium and the platinum catalyst, and protons and electrons may migrate under all conditions of no humidity, low humidity and suitable humidity. That is, the performance of the fuel cell can be secured under all conditions. Furthermore, the proton-conducting polymer serves as an adhesive to adhere platinum to the carbon support medium, such that platinum catalyst particles can be firmly fixed, movement or aggregation of platinum can be reduced upon operation, and efficiency and durability of fuel cell catalysts can thus be improved. Consequently, the operation scope of fuel cells is expanded, factors deteriorating functions are reduced, performance and efficiency are improved and long-term durability is strengthened.

As apparent from the fore-going, the non-aqueous fuel cell catalyst according to the present disclosure has the following effects.

First, because protons and electrons may migrate through a polymer membrane under all conditions including no-humidity, low humidity and suitable humidity, the performance of the fuel cell may be secured under all humidity conditions.

Second, because a polymer serves as an adhesive such that platinum catalyst particles can be firmly fixed, movement or aggregation of platinum can be avoided upon operation, and catalyst efficiency and durability can thus be improved.

Third, since factors, which cause deterioration in functions, are reduced by expanding the operation scope of fuel cells, performance, efficiency and long-term durability can be improved.

Although exemplary embodiments of the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. A non-aqueous fuel cell catalyst comprising:
a carbon support medium;
a coating layer which is coated by a proton-conducting polymer on a surface of the carbon support medium; wherein the proton-conducting polymer includes a phosphoric acid group;
a support member comprising platinum or a platinum alloy supported on the coating layer.

2. The non-aqueous fuel cell catalyst according to claim 1, wherein the proton-conducting polymer comprises at least one selected from the group consisting of polybenzoimidazole, polyetherketone, polyester, polyimide, polystyrene and polyamide.

3. The non-aqueous fuel cell catalyst according to claim 1, wherein the carbon support medium comprises at least one selected from the group consisting of a carbon nanotube (CNT), a fullerene, graphene and a mixture thereof.

4. The non-aqueous fuel cell catalyst according to claim 1, wherein the coating layer has a thickness within a range of 0.5 to 5 nm.

5. The non-aqueous fuel cell catalyst according to claim 1, wherein the coating layer comprises at least one selected from the group consisting of 1,1′-bis(diphenylphosphino)ferrocene; 3-bromopropyl amine, sodium t-butoxide or a mixture thereof; and bis(dibenzylideneacetone)palladium, dimethylacetamide, dimethylformamide or a mixture thereof.

6. The non-aqueous fuel cell catalyst according to claim 5, wherein a content of the 1,1′-bis(diphenylphosphino)ferrocene is within a range of 10 to 30 wt %, based on 100 wt % of the proton-conducting polymer, a content of the 3-bromopropyl amine is within a range of 40 to 80 wt %, based on 100 wt % of the proton-conducting polymer, a content of the sodium t-butoxide is within a range of 5 to 20 wt %, based on 100 wt % of the proton-conducting polymer, and a content of the bis(dibenzylideneacetone)palladium is within a range of 10 to 30 wt %, based on 100 wt % of the proton-conducting polymer.

7. The non-aqueous fuel cell catalyst according to claim 1, wherein the phosphoric acid group is chemically bonded to the proton-conducting polymer.

8. A method of manufacturing a non-aqueous fuel cell catalyst comprising steps of:
mixing a carbon support medium with a proton-conducting polymer including a phosphoric acid group;
sealing the mixture in a vial;
reacting the sealed mixture in a microwave reactor;
adding ethylene glycol (EG) and hexachloroplatinic acid (H₂PtCl₆) to the reacted mixture;
heating and refluxing the resulting mixture to 120° C. using a total condenser or a partial condenser; and
centrifuging the refluxed mixture and then washing the same.

9. The method according to claim 8, wherein the proton-conducting polymer comprises at least one selected from the group consisting of polybenzoimidazole, polyetherketone, polyester, polyimide, polystyrene and polyamide.

10. The method according to claim 8, wherein the carbon support medium comprises at least one selected from the group consisting of a carbon nanotube (CNT), a fullerene, graphene and a mixture thereof.

11. The method according to claim 8, wherein, in the step of mixing, at least one selected from the group consisting of 1,1′-bis(diphenylphosphino)ferrocene; 3-bromopropyl amine, sodium t-butoxide or a mixture thereof; and bis(dibenzylideneacetone)palladium, dimethylacetamide, dimethylformamide or a mixture thereof is further mixed.

12. The method according to claim 8, wherein the step of reacting the sealed mixture is carried out at a temperature within a range of 150 to 200° C. for a time within a range of 1 to 3 hours.

13. The method according to claim 8, wherein the hexachloroplatinic acid (H₂PtCl₆) has a platinum support ratio of 20 to 65% with respect to carbon and the ethylene glycol is a 60% aqueous solution.
